(19) United States
(12) Patent Application Publication
(10) Pub. No.: US 2010/0299878 A1
(43) Pub. Date: Dec. 2, 2010

(54) HINGE AND ELECTRONIC DEVICE EMPLOYING THE SAME

(75) Inventor: JUI-HSIANG LIN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/617,889

(22) Filed: Nov. 13, 2009

(30) Foreign Application Priority Data
May 26, 2009 (CN) 200920303677.7

(51) Int. Cl. E05D 5/12

(52) U.S. Cl. 16/380

(57) ABSTRACT

An electronic device includes a base, a cover pivotally attached to the base, and a hinge including a fixing member and a shaft rotating about the fixing member. The fixing member includes a locating plate including a first surface and a second surface opposite to the first surface, a first sleeve bending from the second surface of an end of the locating plate along a first direction, a second sleeve bending from the first surface of the end of the locating plate along a second direction opposite to the first direction, and a tongue portion between the first sleeve and the second sleeve. The shaft includes a rotating portion rotatably received in the first and second sleeves, a fastening portion fixed in the base, and a blocking portion. The rotating portion defines a groove to partly receive the tongue portion, preventing the shaft from disengaging from the fixing member.

### BACKGROUND

1. Technical Field

The present disclosure relates to electronic devices, and more particularly to an electronic device with a hinge.

2. Description of Related Art

In electronic devices, such as mobile phones, notebooks, personal digital assistants (PDAs), for example, hinges are required to pivotally connect covers and bases of the electronic devices. A frequently used hinge includes a fixing member and a shaft rotatably received in the fixing member. However, the hinge has no structure to retain the shaft in the fixing member, resulting in possible disengagement of the shaft from the fixing member and, accordingly, the cover from the base.

Therefore, a need exists in the industry to overcome the described limitations.

### BRIEF DESCRIPTION OF THE DRAWINGS

FIG. 1 is an exploded, isometric view of an electronic device of an exemplary embodiment of the disclosure.

FIG. 2 is an enlarged, exploded, isometric view of a hinge of FIG. 1.

FIG. 3 is an assembled view of FIG. 2.

FIG. 4 is an assembled view of FIG. 1.

FIG. 5 is a schematic diagram of first and second sleeves applied on a rotating portion of FIG. 3.

### DETAILED DESCRIPTION

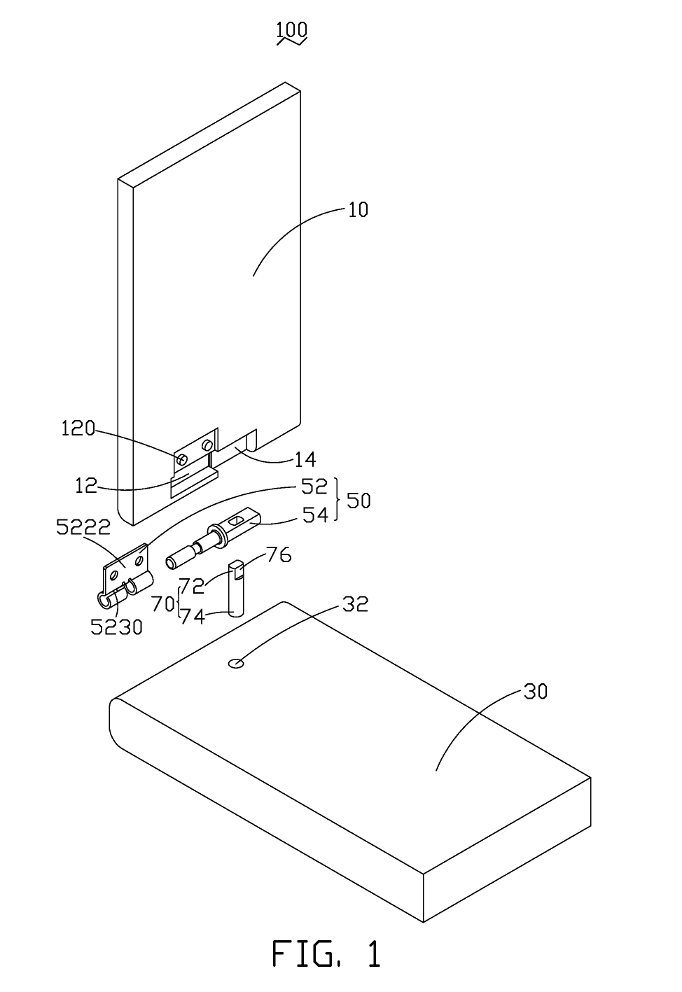

Referring to FIG. 1, an electronic device 100 of an exemplary embodiment of the present disclosure is illustrated. The electronic device 100 includes a cover 10, a base 30, and a hinge 50. The electronic device 100 may be a mobile phone, or a notebook, but the disclosure is not limited thereto.

The cover 10 is pivotally attached to the base 30, and includes a first receiving portion 12 and a second receiving portion 14 in communication with the first receiving portion 12. The first and second receiving portions 12, 14 are adjacent to the base 30. A pair of separate locating posts 120 projects from the first receiving portion 12.

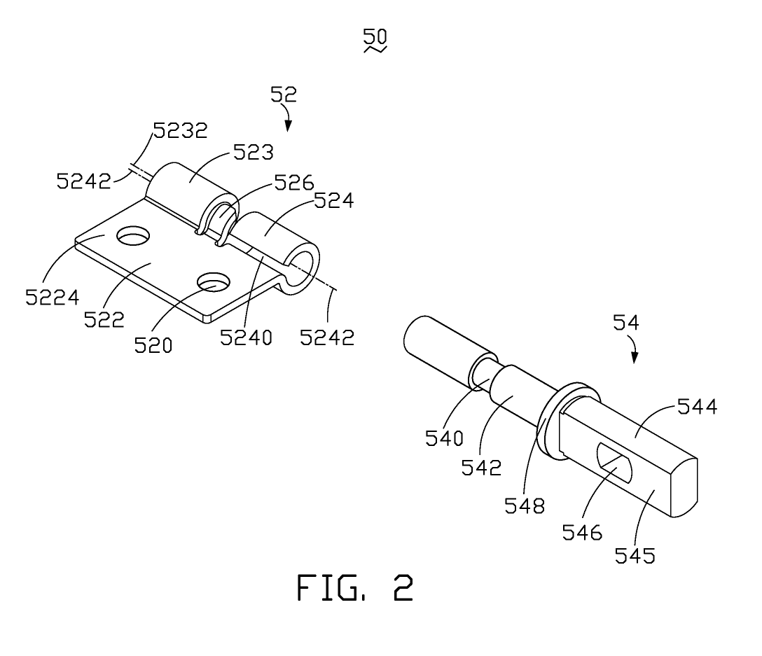

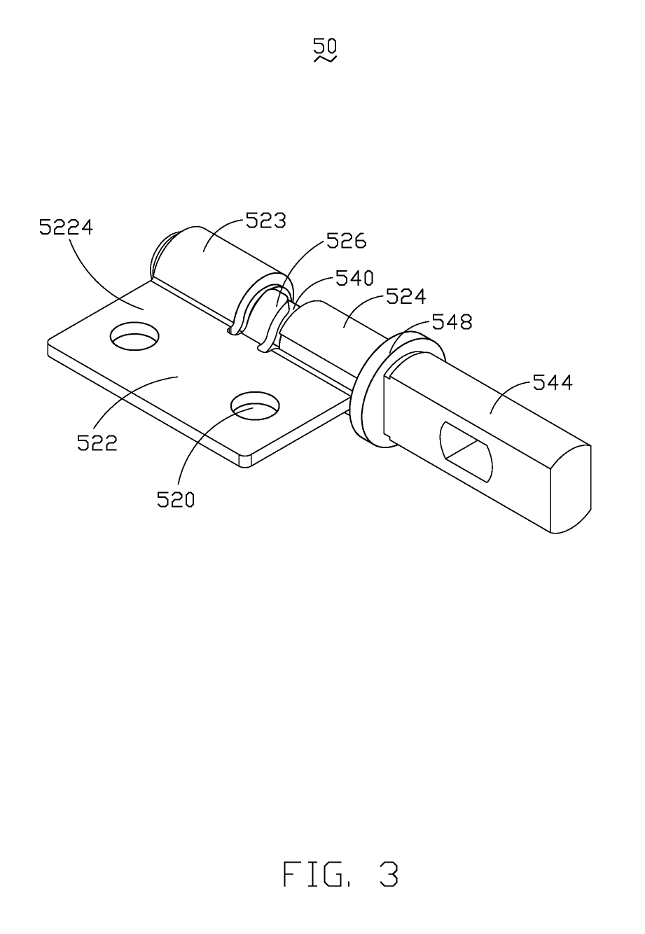

Referring to FIG. 2 and FIG. 3, the hinge 50 includes a fixing member 52 mounted on the cover 10, and a shaft 54 rotating about the fixing member 52. The fixing member 52 includes a locating plate 522 including a first surface 5222 and a second surface 5224 opposite to the first surface 5222, a first sleeve 523, a second sleeve 524, and a tongue portion 526. The locating plate 522 defines a pair of locating holes 520. The pair of locating posts 120 of the cover 10 is received in the pair of locating holes 520 to attach the fixing member 52 of the hinge 50 to the cover 10.

The first sleeve 523 bends from the second surface 5224 of an end of the locating plate 522 along a first direction, and a first slot 5230 is formed between the first sleeve 523 and the first surface 5222 of the locating plate 522. In the illustrated embodiment, the first direction may be a clockwise direction or an anti-clockwise direction. The second sleeve 524 bends from the first surface 5222 of the end of the locating plate 522 along a second direction opposite to the first direction, and a second slot 5240 is formed between the second sleeve 524 and the second surface 5224 of the locating plate 522. Thus, the first and second sleeves 523, 524 provide resilience sufficient to rotatably receive the shaft 54 therein. A radius of the first sleeve 523 is substantially equal to a radius of the second sleeve 524. A first axial line 5232 of the first sleeve 523 is parallel to a second axial line 5242 of the second sleeve 524. In other words, the first sleeve 523 and the second sleeve 524 are not coaxial.

The tongue portion 526 is positioned between the first sleeve 523 and the second sleeve 524. A distance between a central line of the tongue portion 526 and the first axial line 5232 of the first sleeve 523 is less than the radius of the first sleeve 523, and a distance between central line of the tongue portion 526 and the second axial line 5242 of the second sleeve 524 is less than the radius of the second sleeve 524.

The shaft 54 includes a rotating portion 542, a fastening portion 544 attached to the base 30, and a blocking portion 548 between the rotating portion 542 and the fastening portion 544. The fastening portion 544 includes a pair of opposite planes 545, and a fixing hole 546 defined in a central portion of the fastening portion 544 and extending through the pair of planes 545. A radius of the blocking portion 548 is greater than a radius of the fastening portion 544 or the rotating portion 542. The rotating portion 542 is rotatably received in the first and second sleeves 523, 524, and defines a groove 540 in a central portion thereof to partly receive the tongue portion 526 of the fixing member 52. A width of the groove 540 is greater than a width of the tongue portion 526. A radius of the rotating portion 542 is slightly greater than the radius of the first sleeve 523 or the second sleeve 524.

The electronic device 100 further includes a fixing post 70 including a first end 72 including a pair of opposite planes 76, and a second end 74.

The base 30 defines a receiving hole 32 in which the second end 74 of the fixing post 70 is received, and the first end 72 of the fixing post 70 is received in the fixing hole 546, so that the shaft 54 is attached to the base 30.

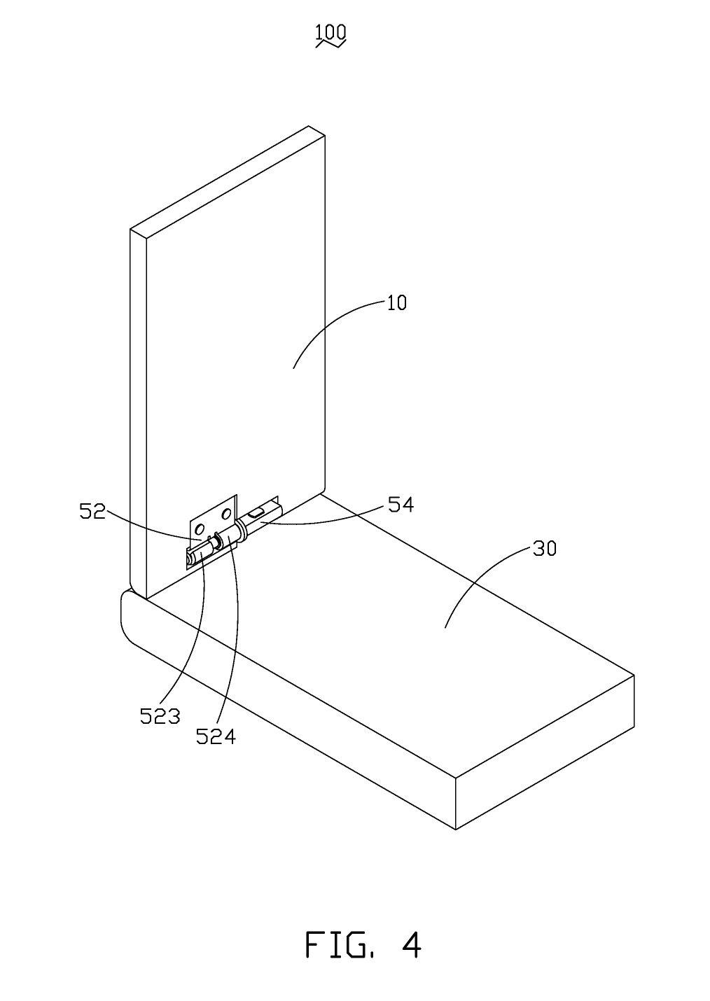

Referring to FIG. 4, in assembly, the rotating portion 542 of the shaft 54 is rotatably received in the first and second sleeves 523, 524 of the fixing member 52 with the tongue portion 526 of the fixing member 52 being partly received in the groove 540 of the shaft 54. The fixing member 52 of the hinge 50 is fixed in the first receiving portion 12 of the cover 10. The shaft 54 is received in the second receiving portion 14 of the cover 10, and is attached to the base 30 via the fixing post 70 being respectively fixed in the fixing hole 546 of the shaft 54 and the receiving hole 32 of the base 30. Thus, the hinge 50, the base 30, and the cover 10 are assembled to the electronic device 100. In this assembled state, the rotating portion 542 of the shaft 54 can rotate relative to the first and second sleeves 523, 524 of the fixing member 52 so that the cover 10 can pivot about the base 30.

Because the tongue portion 526 between first sleeve 523 and the second sleeve 524 is partly received in the groove 540 of the shaft 54, and a distance between a central line of the tongue portion 526 and the first axial line 5232 of the first sleeve 523 or the second axial line 5242 of the second sleeve 524 is less than the radius of the first sleeve 523 or the second sleeve 52, movement of the shaft 540 along a direction parallel to the first axial line 5232 or the second axial line 5242 is limited, as a result, the shaft 54 is prevented from disengaging from the fixing member 52 during use.

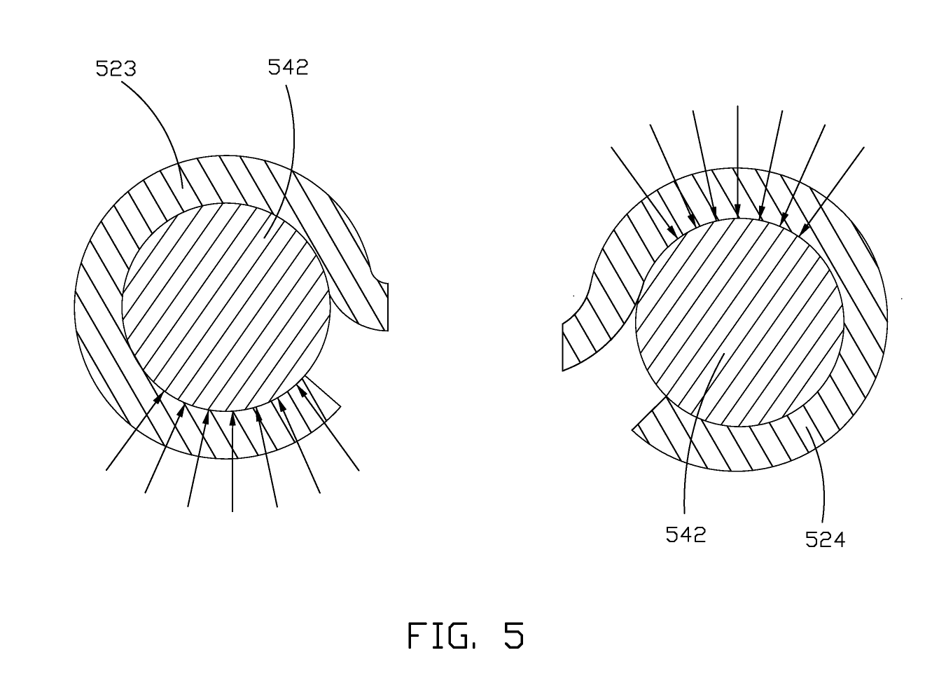

Referring to FIG. 5, in practical application, the first sleeve 523 would apply a first force along a third direction on the shaft 54 and the second sleeve 524 would be apply a second force along a fourth direction opposite to the third direction on the shaft 54 when the rotating portion 542 of the shaft 54 rotates about the first and second sleeves 523, 524 of the fixing member 52. Thus, an offset of a center of the first sleeve 523 or the second sleeve 524 relative to the locating plate 522 and the force applied on the shaft 54 is reduced, avoiding damage to rotating portion 542 of the shaft 54 and the first and second sleeves 523, 524 of the fixing member 52.

While an embodiment of the present disclosure has been described above, it should be understood that it has been presented by way of example only and not by way of limitation. Thus the breadth and scope of the present disclosure should not be limited by the above-described embodiments, but should be defined only in accordance with the following claims and their equivalents.

What is claimed is:

1. An electronic device comprising:
a base;
a cover pivotally attached to the base; and
a hinge connecting the cover and the base, the hinge comprising:
a fixing member mounted on the cover and comprising a locating plate comprising a first surface and a second surface opposite to the first surface, a first sleeve bending from the second surface of an end of the locating plate along a first direction, a second sleeve bending from the first surface of the end of the locating plate along a second direction opposite to the first direction, and a tongue portion between the first sleeve and the second sleeve; and
a shaft rotating about the fixing member and comprising a rotating portion rotatably received in the first and second sleeves, a fastening portion fixed in the base, and a blocking portion between the rotating portion and the fastening portion, wherein the rotating portion defines a groove corresponding to the tongue portion;
wherein the tongue portion is partly received in the groove, preventing the shaft from disengaging from the fixing member.

2. The electronic device as recited in claim 1, wherein a first slot is formed between the first sleeve and the first surface of the locating plate, and a second slot is formed between the second sleeve and the second surface of the locating plate.

3. The electronic device as recited in claim 2, wherein a radius of the first sleeve is substantially equal to a radius of the second sleeve.

4. The electronic device as recited in claim 3, wherein a first axial line of the first sleeve is different from a second axial line of the second sleeve.

5. The electronic device as recited in claim 4, wherein a distance between a central line of the tongue portion and the first axial of the first sleeve is less than the radius of the first sleeve, and a distance between a central line of the tongue portion and the second axial of the second sleeve is less than the radius of the second sleeve.

6. The electronic device as recited in claim 3, wherein a radius of the rotating portion is slightly greater than the radius of the first sleeve or the second sleeve.

7. The electronic device as recited in claim 1, wherein the cover defines a first receiving portion and a second portion in communication with the first receiving portion to receive the hinge.

8. A hinge comprising:
a fixing member comprising a locating plate comprising a first surface and a second surface opposite to the first surface, a first sleeve bending from the second surface of an end of the locating plate along a first direction, a second sleeve bending from the first surface of the end of the locating plate along a second direction opposite to the first direction, and a tongue portion between the first sleeve and the second sleeve; and
a shaft rotating about the fixing member and comprising a rotating portion rotatably received in the first and second sleeves, a fastening portion fixed in the base, and a blocking portion between the rotating portion and the fastening portion, wherein the rotating portion defines a groove corresponding to the tongue portion;
wherein the tongue portion is partly received in the groove to prevent the shaft from disengaging from the fixing member.

9. The hinge as recited in claim 8, wherein a first slot is formed between the first sleeve and the first surface of the locating plate, and a second slot is formed between the second sleeve and the second surface of the locating plate.

10. The hinge as recited in claim 9, wherein a radius of the first sleeve is substantially equal to a radius of the second sleeve.

11. The hinge as recited in claim 10, wherein a first axial line of the first sleeve is different from a second axial line of the second sleeve.

12. The hinge as recited in claim 11, wherein a distance between a central line of the tongue portion and the first axial of the first sleeve is less than the radius of the first sleeve, and a distance between a central line of the tongue portion and the second axial of the second sleeve is less than the radius of the second sleeve.

13. The hinge electronic device as recited in claim 10, wherein a radius of the rotating portion is slightly greater than the radius of the first sleeve or the second sleeve.
